(19) United States
(12) Patent Application Publication
(10) Pub. No.: US 2004/0026899 A1
(43) Pub. Date: Feb. 12, 2004

(54) Compact wheelbarrows and carts including stowable wheels, supports, and handles

(76) Inventor: Richard N. Shapiro, Virginia Beach, VA (US)

Correspondence Address: LARSON & TAYLOR, PLC, 1199 NORTH FAIRFAX STREET, SUITE 900, ALEXANDRIA, VA, 22314, US

(21) Appl. No.: 10/622,172

(22) Filed: Jul. 18, 2003

Related U.S. Application Data
(63) Continuation-in-part of application No. 10/157,980, filed on May 31, 2002.
Application No. 10/157,980 is a continuation-in-part of application No. 09/604,769, filed on Jun. 28, 2000, now Pat. No. 6,581,945.
(63) Continuation-in-part of application No. 10/346,112, filed on Jan. 17, 2003.
Application No. 10/346,112 is a continuation-in-part of application No. 10/143,831, filed on May 14, 2002, now abandoned.
Application No. 10/143,831 is a continuation-in-part of application No. 09/604,769, filed on Jun. 28, 2000, now Pat. No. 6,581,945.

(51) Int. Cl. B62B 1/18

(52) U.S. Cl. 280/653

(57) ABSTRACT

Wheelbarrows and similar type carts are notoriously bulky, unwieldy devices. Methods are provided to fold and stow all components of such devices into an ultra thin, compact profile. One or more wheel support units pivot and latch into the thin stowed profile along with the underside support and handle components. Convenient stowing and nesting of such devices for display or transport is also provided.

### RELATIONSHIP TO ALL OTHER APPLICATIONS

This application is a continuation-in-part of U.S. patent application Ser. No. 10/157,980 filed on May 31, 2002 (compact wagons), which is a continuation-in-part of Ser. No. 09/604,769 filed on Jun. 28, 2000. Additionally, this application is a continuation-in-part of Ser. No. 10/346,112 filed on Jan. 17, 2003, which is a continuation-in-part of Ser. No. 10/143,831 filed on May 14, 2002, which is a continuation-in-part of Ser. No. 09/604,789 filed on Jun. 28, 2000.

Shapiro's previous U.S. applications include, Ser. No. 09/271,274, filed on Mar. 17, 1999, now U.S. Pat. No. 6,220,611, granted Apr. 24, 2001.

### FIELD OF THE INVENTION

The present invention relates to wheelbarrows, wheeled carts, and cargo carriers, including one or more wheels, which may include combinations of stowable support stands and stowable handles. Various embodiments focus on wheelbarrows, and one or more wheeled carts; however, a wide variety of cargo and equipment-carrying carriers may be adapted with the folding wheel structures described.

### BACKGROUND OF THE INVENTION

In continuation-in-part U.S. Ser. No. 10/346,112, filed on Jan. 17, 2003, disclosures were made relating to compact, folding walking or jogging strollers and similar cargo carriers which application disclosed new and unique pivoting and stowable wheel mechanism for a single, typically forward wheel, on jogging or walking strollers, but also broadly adaptable to other cargo carriers, with different wheel configurations. In another U.S. patent application, Ser. No. 10/157,980, the applicant disclosed compact wagon and cart carrier devices with pivoting and stowable wheels, underside supports, and handles. This particular application integrates several innovations of the applicant described in the jogging stroller/cargo carrier application referenced above, with various disclosures adapted from the compact wagon/cart application, Ser. No. 10/157,980. A number of these innovations are therefore integrated for wheelbarrows or similar wheeled carts disclosed herein, notably detailed figures and disclosures are included in each of the referenced prior applications, either depicting the typically, but not exclusively, “forward” wheel mechanism herein some which were disclosed in Ser. No. 10/346,112, as well as several other components of carrier stands or underside supports and handles, some disclosed in Ser. No. 10/157,980.

### SUMMARY OF THE INVENTION

This application provides integration of a number of innovations of the applicant in separate earlier applications but particularly applied now to single- or multi-wheeled wheelbarrows and carts including: methods to latch and release the forward wheel of a wheelbarrow or cart from an operative position into a stowed position parallel with, at least nearly within the side elevational profile and perimeter of said device, methods to latch and release one or more varieties of underside supports for the cart device and to allow them to stow substantially within the side elevational profile of the cart and/or to serve as handles when in the stowed position, methods to provide for two separate wheelbarrow handles or a u-shaped wheelbarrow handle that have an operative position, and a second, stowed position flush with or within the side elevational profile of the cart device, methods to provide that the underside supports interlock and/or mechanically, automatically pivot and interact with one or more of the handles provided with the carrier device, methods whereby interaction between either one or more underside supports and one or more handle components serve to latch, move, or release the adjacent component; and unique methods to nest or stack the operative and stowed devices in a convenient fashion.

Further features and advantages of the present invention will be set forth in, or apparent from, the detailed description of preferred embodiments thereof which follows.

### BRIEF DESCRIPTION OF THE DRAWINGS

FIG. 1 is a side elevational view of the wheelbarrow or cart 1-A in a stowed position, indicating the operative position of various components in ghost perspective and also the nesting of such devices as well. This is the preferred cover page figure;

FIG. 2 is a front end elevational perspective of the cart device 1-A, slightly elevated, partly broken away;

FIG. 3 is a side perspective of the forward wheel of the cart device 1-A, where the forward wheel structure has been released from the operative position and is partly pivoted downward;

FIG. 4 is a side elevational perspective of the forward wheel system of cart device 1-A, released from the operative position and turned on its axis 90 degrees in an intermediate position preceding the fully-stowed position;

FIG. 5 is a top plan view of the cart device 1-A, inverted, showing the underside with a ghost perspective of the forward wheel system in a stowed position, and further including one embodiment of the underside supports in a stowed position;

FIG. 5-A shows a detached perspective of an alternative embodiment of an underside support of a one-piece design;

FIG. 6 is a top plan view, of the cart device underside, inverted, showing two independent handle embodiments, with the ghost perspective showing their stowed position.

FIG. 7 is a top plan view of the cart, inverted, depicting one embodiment of a u-shaped handle, in an operative and stowed position;

FIG. 8 is a top plan view of the cart, inverted, depicting one embodiment of a set of two independent handles;

FIG. 9 is a side elevational view of device 1-A, elevated, depicting one embodiment where movement of the handle element between the operative and stowed position causes corresponding movement to a support stand element;

FIG. 9-A is a side elevational view of device 1-A, elevated, depicting one embodiment where movement of the handle element between the operative and stowed position causes corresponding movement to a support stand element;

FIG. 10 is a side elevational view of device 1-A focusing on an alternative handle and underside support configuration.

### DESCRIPTION OF THE PREFERRED EMBODIMENTS

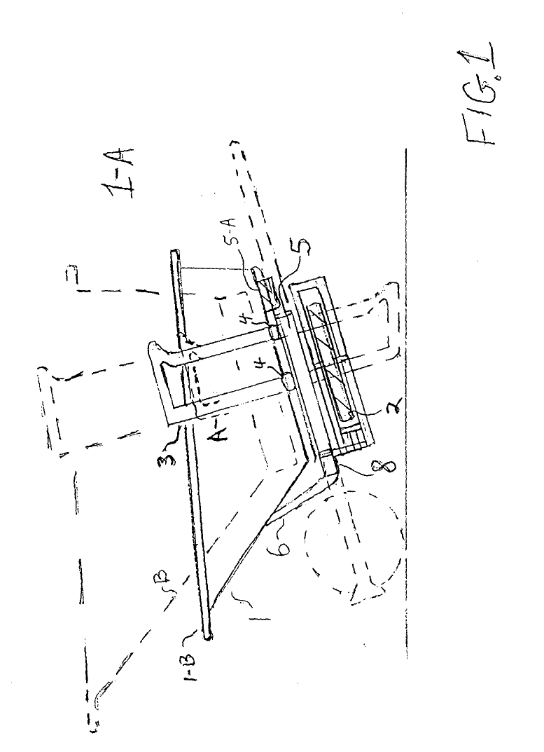

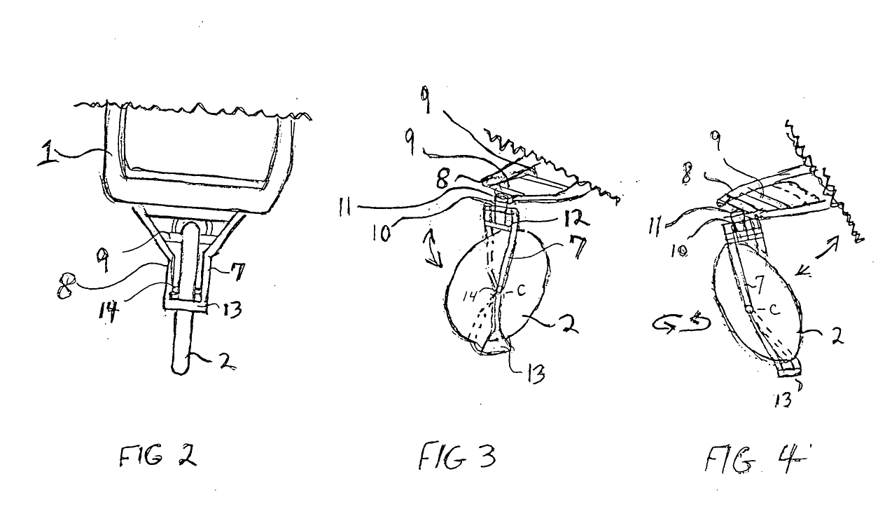

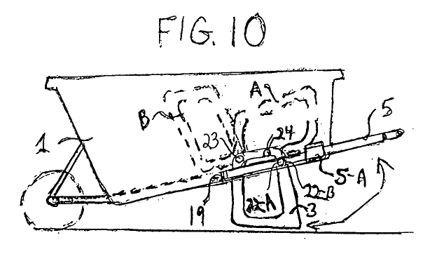

Referring to the drawings, FIG. 1 shows a wheelbarrow or cart device, 1-A, in a fully-stowed position, with various components shown in the operative position in ghost perspective as described. The wheelbarrow or cart device support base is shown at 1 which may be any suitable material and include formed stub walls and may include a lip around the top perimeter, 1-B. The upwardly projecting wall or walls may be extremely minimal rather than forming a complete enclosed bed as shown in FIG. 1. A wheel, 2, is shown in a stowed position in FIG. 1 and is pivotably mounted on the fixed frame wheel stop/brace 8. Further detail of the pivoting and stowable wheel structure is described further in FIGS. 2 through 4. More than one wheel may be employed, and the wheels may be arranged in any configuration (not shown). The tire, 2, is stowed in a plane substantially parallel to the base of the cart device, 1. However, the same tire, 2, may be released from its stowed, latched position shown in FIG. 1, and moved into a fully operative and latched position shown in ghost perspective in FIG. 1. The preferred embodiment in FIG. 1 also shows a pair of underside supports, 3, one of which is shown in the stowed position. In the ghost perspective of the underside support, 3, the operative position can be seen and only one of the two underside supports is shown in FIG. 1. The ghost perspective, A, indicates that the underside support, 3, may stow fully within the device's side elevational profile or may extend slightly above the lip, 1-B, allowing the pair of underside supports, in the stowed position, to serve also as pull or lift handles when the device is fully stowed and nested. The underside support, 3, may pivot or move to stow along one or more support mounts, 4, and be provided with a variety of latching means, whether on the supports or mounted to the support base. In the embodiment in FIG. 1, the pair of underside supports pivot approximately 180 degrees between the operative and stowed positions. It is noted that FIGS. 5, 9, 9-A, and 10 show several alternative underside support arrangements. FIG. 1 also shows one of a pair of handles, 5. One of the handles is shown in a fully stowed position which generally is flush to the cart device in the side elevational profile. A ghost perspective of handle 5 shows it in its fully operative position where it is one of two substantially straight handles typically adapted to a wheelbarrow. In the embodiment shown in FIG. 1, the handle may be moved from the operative to the stowed position by one of several methods: an extensible or telescoping method, or the handle may have one or more stages and may pivot between the operative to the stowed position by means of a hinge or interlock between two stages of the handle (not shown). FIG. 1 shows a latch, 5-A, which may be of any type, or a simple hinge mount allowing pivot latch movement of up to 180 degrees so the user may move the latch to release one of the handle components, and then pivotably snap or resiliently retain the latch, 5-A, on or over a component of the handle, 5, to form the latch position. Last, FIG. 1-A also shows that a forward wheel support, 6, may be mounted between a portion of the fixed frame wheel stop/brace, 8, and a portion of the cart device, 1. One or more wheel bracket supports, 6, may serve to further secure the forward wheel brace, 8, to the cart to form a sturdy support. The interior facing walls and base support may be suitably designed or shaped to receive, on a selectively removable basis, any nature of equipment or secondary devices (not shown) within the bed/base area.

FIGS. 2 through 4 show the detail of the method to detach the forward tire, 2, from the operative position to both an intermediate and a stowed position. First, FIG. 2 shows the fixed frame wheel stop/brace, 8, of the forward wheel structure and one or more wheel fork cross or lateral braces, 9. As can be seen in both FIG. 2 and FIG. 3, there is forward fork through bolt, 14, which secures the tire, 2, inside the wheel fork, 7. There may instead be a single-sided wheel attachment (not shown). The wheel fork may also include a second, lateral brace, 12. Importantly, FIG. 3 shows the wheel fork pivot head, 10, and the wheel fork release latch, 11, which are critical to the locking and release of the wheel, 2. In this particular preferred embodiment, there is a push button release latch shown at 11, but any suitable latch may be employed, including a movable resilient latch or spring biased liftable latch which the user manipulates in order to effect release (not shown). The wheel fork pivot head, 10, is mounted to the fixed frame wheel stop/brace, 8, by any suitable method permitting the pivot and rotation described generally herein. Also, FIG. 3 includes an optional wheel fork extension and stand, 13, which may be extended along the forward wheel fork, 7. In a typical wheelbarrow or cart device, the user may desire to push the wheelbarrow into a partly inverted or tilted position to dump the cargo or load. This occurs more easily where there is a stop or other suitable brace component surrounding a portion of the forward wheel to provide friction with the rolling surface to facilitate the dumping movement. Additionally, a cowl or cover (not shown) may be formed over any portion of the wheel, 2, and affixed along the forward wheel fork, 7.

FIG. 4 is the last in the sequence of FIGS. 2, 3, and 4, which also shows further movement of the forward wheel toward the stowed position. The same components described in FIG. 2 and 3 are shown, but the entire sequence shows that in FIG. 2, the forward wheel is fully latched in the operative position. In FIG. 3, the user has manipulated the wheel fork release latch, 11, which allows for release of the tire, 2, from the latched, operative position and the tire has been pivoted downward on its mounting axis, but is still orthogonal to the underside base of the cart device. However, as shown in FIG. 4, the user has rotated the tire, 2, along its pivot axis on the wheel fork pivot head, 10, effecting a 90 degree tire rotation along its axis. Once this is accomplished, the user then presses and pivots the tire up toward a parallel position in relation to the underside base of the cart device, where it occupies its stowed and latched position as shown in the original FIG. 1 at 2. While the embodiment in FIG. 1 shows a single forward wheel, the cart device profile may be expanded and more than one wheel (rear, side, or forward) mount may be utilized, or the wheel or wheels may even pivot up and over the support base, rather than down and under, if extremely short stub walls are adapted. FIG. 1 also shows two substantially straight single handles, but it is apparent that instead a unshaped single handle may be utilized or shaped handles that stow flush with the product profile may be adopted. A pair of underside supports are shown, but any suitable single underside support may be employed, or more than two may be adapted as well.

FIG. 5 shows an underside view of cart device, 1-A, and the underside of the base, 1, is shown to include a pair of matching underside supports, 3. In the view shown, the underside supports occupy a stowed position. A stowed position may be maintained by any suitably shaped receiving element, 15, which causes resilient contact between the underside supports, 3, and the receiving element, 15. Although one element, 15, is shown in FIG. 5, more than one may be adapted and the receiving element may be nothing more than a shaped portion of the base device underside. The letter A in FIG. 5 denotes that the upper portion of each of the underside supports (upper when operative), 3, may be shaped so that when the underside support, 3, is moved from the stowed position shown, to the operative position orthogonal to the cart device, the shaped upper portion of the foot of the underside support may interact with any suitable cavity or protrusion formed on the cart underside to assist in resiliently retaining the underside support in the operative, orthogonal position to the cart device base (not shown). Also, not shown is that the supports may partly overlay each other, and still resiliently be retained in the stowed position to each other and the device base. FIG. 5 also shows, from the underside, one wheel structure, 2, in an operative position. Letter “D” in ghost perspective shows the general perspective of the tire, 2, in the stowed position parallel with the underside of the cart base.

FIG. 5-A shows an alternative one piece underside support 3-A, which may include shaped foot sections, 3, to cause resilient contact with the cart device to retain it either in an operative or in a stowed position. The underside receiving element, 15, shown in FIG. 5 may be re-shaped to retain the support 3-A.

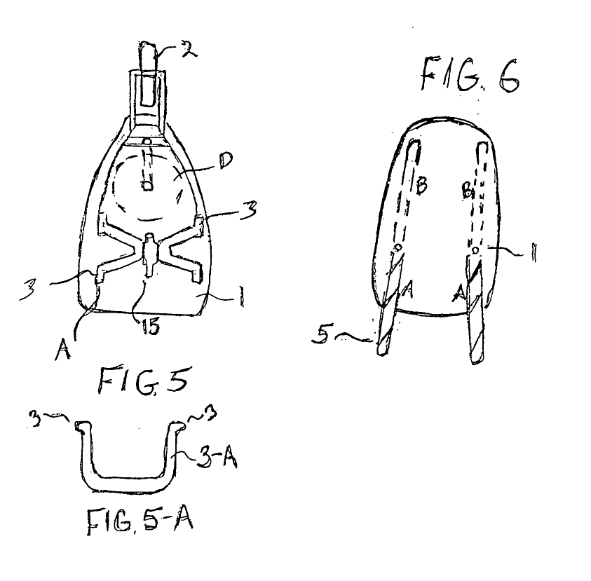

FIG. 6 again shows an underside view of the same cart device base, 1, instead focusing on a pair of substantially elongated handles, 5. FIG. 6 indicates that the handle, 5, has a component portion, A, which operates as the handle in the operative position shown. However, any suitable movement of the handles, 5, may be effectuated so that the entire handle is stowed substantially within the side elevational profile of the cart device, substantially flush with the cart base as shown at perspective B. The handle may take on one of several embodiments: 1 the handle stages may simply telescope or extend between the positions A and B shown; and, 2 the handle may be formed of at least two stages, and stage A may pivot about 180 degrees in any plane so that stage A folds substantially contiguous to stage B by virtue of an interlock or hinge between the two stages. Where the second method above is adopted, that is two stages interlock and one stage pivots from the operative to the stowed position, the pivot may be along the underside of the cart device 180 degrees, or the pivot may be 180 degrees in a plane outside the cart device wall parallel with the base underside. FIG. 1 also shows an optional pair of latches, 5-A, which may serve to further latch the handles, 5, in the operative position.

FIG. 7 shows a view of the underside of the cart device 1-A which includes a generally u-shaped handle, 16. Handle 16 may be extended and recessed between an operative position as shown furthest away from the cart base, 1, and may occupy a recessed or stowed position closely contiguous to the cart device base structure, as shown in ghost perspective. FIG. 7 also shows at “B” that a portion of the underside frame may actually be extended along the end opposite the extension portion of the handle so that the fixed frame wheel stop/brace, 8, may actually be incorporated as part of the frame structure along with the handle.

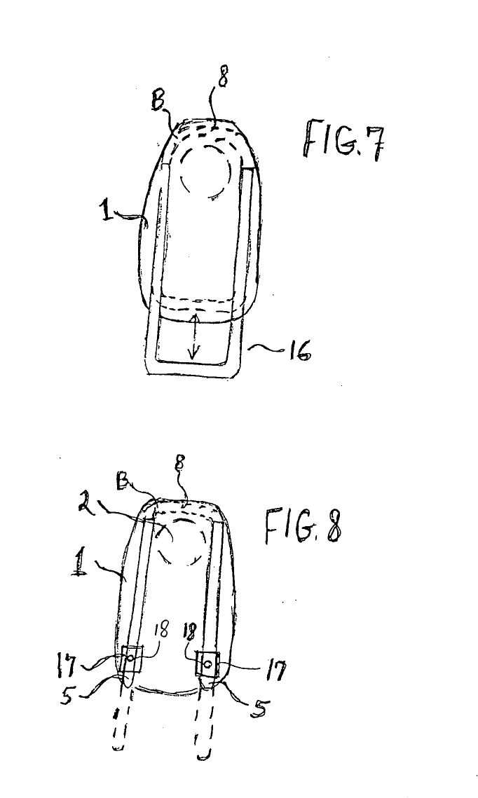

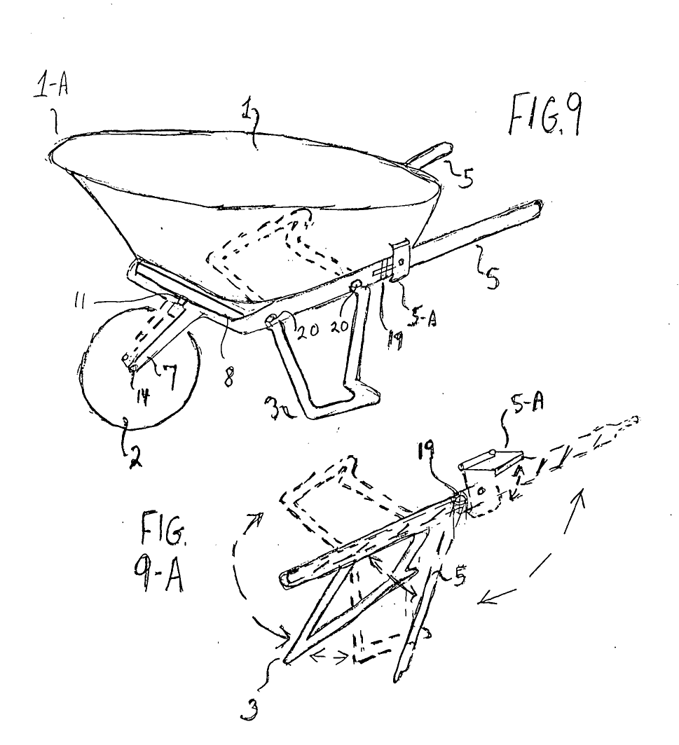

FIG. 8 shows another alternative embodiment of the handle structures for the cart device, 1. Again, the view is of the underside, and it shows a ghost perspective of the wheel, 2, in a stowed position. FIG. 8 shows at least 2 generally elongated handle structures, 5, in their stowed position, and the ghost perspective shows the extended or operative handle position. The latching method for the handle structures may include a threaded, generally cylindrical manually rotatable structure, 17, which in use is turned a half turn to release and then is rotated in the opposite direction to tighten the handle in either the stowed or the operative position. These types of tightening rings are commonly known in the art with regard to extendable handles. 18 indicates that rather than the rotatable rings, 17, an alternative latching method may be a simple spring-biased detente, 18, which the user presses in to move the handle from the extended to the recessed position. Again, FIG. 8 also shows that the underside handle frame structure may also integrate the forward frame wheel stop/brace, 8, as shown at B.

Turning to FIG. 9, another embodiment of the cart device, 1-A, is shown with a fixed bed or base structure, 1. The perspective shown is similar to FIG. 1 but focuses most on the mechanism relating to the handle structures, 5, and the support structures, 3, and the embodiment shows an alternative latching and stowing structure for the handle and support components above-mentioned. At 19 is shown a handle interlock/hinge which fixes two separate stages of the handle, 5. A handle latch, 5-A, is shown which may be mounted to any suitable part of the cart device, 1. As shown in FIG. 9-A, in use, when the user pivots or releases the handle latch, 5-A, the handle, 5, may be pivoted along the hinge/interlock point, 19. Movement of this stage of the handle, 5, mechanically causes pivot movement to the underside support, 3. FIG. 9A shows the intermediate position of the handle, 5, and an intermediate pivot motion to the underside support, and the various ghost perspectives show corresponding movement between the two component parts (the handle and the underside support). The mechanical method for the reciprocal and corresponding motion between the two parts is not shown in detail.

FIG. 10 focuses solely on an alternative embodiment for the interaction between an underside support, 3, and a handle, 5, of the device 1-A. As discussed above, there is an interlock mechanism between the two said components. In FIG. 10, the handle, 5, pivots along a hinge point, 19. An optional latch, 5-A, may secure the handle, 5, in the operative position, and when the latch, 5-A, is released, and the handle is pivoted to a stowed position along the pivot point of the hinge, 19, this motion further releases at least one protrusion or recess point, 22-A, formed as part of the handle component, 5, which releases from at least one corresponding protrusion or recess, 22-B, which is formed as a part of the underside support, 3. Thus, as the handle, 5, is further swung into a stowed position, a latching release is effected which allows the underside support, 3, to be pivotably stowed along a cart wall securement point, 23. The underside support, 3, thus pivots along the pivot point, 23, roughly anywhere between 90 and 270 degrees into a stowed position substantially within the side elevational profile of the cart device. To place the device into the operative position, the user would reverse the motion by pivoting the stowed underside support, 3, from a relationship substantially flush against the cart device wall to the operative position, and then the handle, 5, would be pivoted along the hinge point, 19, and this again establishes a latching point between the protrusion or recess on the handle, 22-A, and the corresponding protrusion or recess in the underside support, 22-B, and then the user would latch the handle latch, 5-A. Additionally, the latching of elements 22-A and 22-B, by the handle, 5, may further resiliently interconnect with a protrusion, recess, or cavity formed as part of the cart device, 1, wall (not shown). Alternatively, there may be no actual interlock between the handle, 5, and the underside support, 3, but the handle simply causes resilient support (by any suitable engagement) to the underside support, 3, when the handle, 5, is in the latched position secured by handle latch, 5-A. And in this alternative embodiment (not shown), merely releasing the latch, 5-A, and swinging the handle to its stowed position, allows for the underside support, 3, to be pivoted along the pivot point, 23, into a stowed position. If desired, a detente button or protrusion or recess may be added to either the device wall, 1, or to the underside support, 3, as shown at 24.

Although the invention is described with respect to specific embodiments, it is appreciated that any combination of structures described, or location of stowable wheels, supports or handles may be employed without departing from the spirit of the disclosures herein, and that various carrier shapes, base, and wall configurations may also be adapted.

More generally, although the invention has been described above in relation to preferred embodiments thereof, it will be understood by those skilled in the art that variations and modifications can be effected in these preferred embodiments without departing from the scope and spirit of the invention.

What is claimed is:

1. A wheeled carrier device, said device comprising:
a support base structure including a plurality of upwardly projecting stub walls defining a side elevational profile and an outer perimeter; and
at least one wheel support unit affixed to said support base; said wheel support unit comprising a wheel having an outer periphery, defining a plane and having a central axis of rotation, and said wheel support unit being movable between a first, operative position wherein said wheel is erected to provide rolling support for said support base and wherein the plane defined by said wheel support unit extends substantially orthogonally to the side elevational profile of the support base, and a second, stowed position, the plane defined by said wheel of said wheel support unit being swept through an angle during movement of said wheel support unit between said first and second positions such that the plane defined by said wheel in the second position of said wheel support unit is parallel with and substantially within the side elevational profile of said support base; and
said wheel's central axis of rotation is wholly within, and the wheel's periphery is substantially within, the support base perimeter in said second, stowed position; and
at least one rigid handle secured to the carrier device, and movable from a first operative position, to a stowed position closely adjacent to the support base, substantially within the side elevational profile of the carrier device; and
at least one underside support which is movable from a first, operative position substantially orthogonal to the side elevational profile of the device support base, wherein the underside support affords support between the device support base and a rolling surface, to a second, stowed position substantially within the side elevational profile of said carrier device, and being substantially disposed within the outer perimeter defined by the support base; and
releasable latching means, for positively latching said at least one wheel support unit, said at least one handle, and said at least one underside support in both of said first and second positions thereof.

2. A device in accordance with claim 1 wherein said handle means comprise a pair of substantially elongate handle members, each one independently manipulable.

3. A device in accordance with claim 1 wherein said at least one underside support comprises a pair of support members, each one independently manipulable.

4. A device in accordance with claim 1 wherein the positive latching of said at least one underside support in its operative position additionally serves to positively latch said at least one handle in the handle's operative position, and movement of the underside support to its stowed position correspondingly releases said underside support permitting its movement to said stowed position.

5. A device in accordance with claim 1 wherein the positive latching of said at least one handle in its operative position additionally serves to positively latch said at least one underside support in the underside support's operative position, and movement of the handle to its stowed position correspondingly releases and permits movement of said underside support to said stowed position.

6. A device in accordance with claim 1 wherein the at least one wheel support unit further includes:
at least one arm structure mounted to the central axis of rotation of said wheel support unit;
at least a portion of the at least one wheel support unit further includes at least one brace;
in a first, operative position said brace of said wheel support unit at least partly abuts said support base, and in a second, stowed position at least a part of said brace is detached from said abutment to said support base.

7. A device in accordance with claim 1 in which at least one wheel and its central axis of rotation are directed in an inward direction in a second, stowed position in relation to the at least one underside support.

8. A device in accordance with claim 6 wherein at least one part of said brace is at least partly mounted to the underside of the device support base in said first position, causing gravitational force from downwardly applied weight to the device support base to maintain said first, operative wheel support unit position.

9. A device in accordance with claim 1 wherein at least one user-controlled wheel braking means is mounted to the device.

10. A device in accordance with claim 1 wherein the at least one wheel support unit is fixated against axial rotation is said first, operative, latched position and when unlatched from said position, said at least one wheel is rotated along its axis of rotation and moved into a second, stowed position substantially parallel with the support base, substantially within the side elevational profile of said support base.

11. A device in accordance with claim 1 wherein the latch means which latches and releases the at least one wheel support unit in both said first and second positions is one and the same means.

12. A device in accordance with claim 1 wherein the wheel support unit latch means is recessed within the side elevational profile of the support base of said device.

13. A device in accordance with claim 1 wherein the wheel support unit latch means is mounted to the wheel support unit.

14. A device in accordance with claim 1 wherein said wheel support unit latching means includes at least one spring-biased latch mounted to the wheel support unit.

15. A device in accordance with claim 1 wherein said wheel support unit latching means includes at least one spring-biased latch mounted to the support base.

16. A device in accordance with claim 1 wherein said wheel support unit latching means includes at least one sliding member mounted to the wheel support unit.

17. A device in accordance with claim 1 wherein said wheel support unit latching means includes at least one resiliently movable member mounted to the wheel unit.

18. A device in accordance with claim 1 wherein said wheel support unit latching means includes at least one resiliently movable member mounted to the support base.

19. A device in accordance with claim 1 wherein said support base is designed to hold general cargo.

20. A device in accordance with claim 1 wherein said support base is designed to hold at least one person.

21. A device in accordance with claim 1 wherein a frame structure is at least partly affixed to the support base, and at least partly retains the movable wheel support unit structure, at least part of a handle, and at least part of at least one underside support.

22. A device in accordance with claim 1 wherein a friction element extends from not less than the central axis of rotation, along the radius of said wheel and across at least a portion of said wheel intended to contact the rolling surface and functions as a friction element, and in the operative position, the carrier device is at least partly tilted, and said friction element is caused to engage the rolling surface to brace the carrier device against rolling movement to facilitate cargo discharge.

23. A device in accordance with claim 1 wherein the at least one handle is a substantially un-shaped handle.

24. A device in accordance with claim 1 wherein the handle comprises at least two handle elements and each element has at least two stages which stages are both extensible and retractable.

25. A device in accordance with claim 1 wherein the wheel support unit wheel includes at least a partial cowl which does not contact the rolling surface when the device components are in the operative position, and when the device is moved into a second, partly tilted position, the cowl is moved into a position in friction with the rolling surface, enabling dumping of device cargo without rolling movement of the at least one wheel.

26. A device in accordance with claim 1 wherein at least one handle comprises at least two stages and at least one of said two stages pivots in relation to the support base; and
said pivotable at least one stage is latched against movement in the first, operative position at least partly contiguous to said support base, and said pivotable stage of said handle pivots in relation to the carrier device, and moves into a second stowed position contiguous to the support base.

27. A device in accordance with claim 26 wherein the pivot motion of said stage is near to 180 degrees in a plane generally under the support base.

28. A device in accordance with claim 26 wherein said handle stage pivot motion is near to 180 degrees, along a plane horizontal with the side elevational profile of the side of the device.

29. A device in accordance with claim 1 wherein the handle includes at least two stages and at least one extensible second stage of said handle is latched and secured in a first, operative position by a cylindrically shaped rotatable ring, and further rotational movement of said ring effects release of said second stage of said handle from the first, operative position, and said stage is retracted into a second, stowed position and said rotatable ring is rotated to secure both stages of the handle in the retracted, stowed position.

30. A device in accordance with claim 1 wherein the handle comprises at least two stages and one stage is extensible in relation to said other at least one stage, and in a first, operative position at least one stage is maintained in extended relation to the other stage by virtue of a resiliently maintained detente, and upon manual manipulation of the detente, said one extensible stage is retracted into a second, stowed position inside said at least one other stage of the handle.

31. A device in accordance with claim 1 wherein said at least one underside support with near to a 90 degree angle shape foot portion is orthogonal to the underside support base, and such 90 degree angle shape is in the direction nearest to the first, operative handle side position of said device, which 90 degree shaping prevents the operative carrier device from unintended tilting toward the handle side.

32. A device in accordance with claim 1 wherein said underside supports comprise at least two generally matching supports which in the first, operative position are orthogonal to the underside of the support base and in said second, stowed position, each said underside support is pivoted and moved within the side elevational profile to the underside of the said carrier device.

33. A device in accordance with claim 32 wherein said underside supports at least partially overlay each other in the said second, stowed position.

34. A device in accordance with claim 1 wherein said underside supports comprise at least two matching elements which in a first, operative position are orthogonal to the support base of said device, and in a second, stowed position such supports are pivoted at least near to 180 degrees to a stowed position along the perimeter of the device support base where they are positively latched.

35. A device in accordance with claim 34 wherein said stowed underside supports serve as handles for lifting or manipulating the stowed carrier device.

36. A device in accordance with claim 1 wherein the underside support is comprised of at least one un-shaped underside support.

37. A device in accordance with claim 1 wherein at least one of said underside supports, in said second, stowed position, is resiliently retained to at least part of the outer perimeter of the base of said device.

38. A device in accordance with claim 1 wherein at least one bracing support is mounted to at least a portion of the wheel support unit and to a portion of the perimeter of the support base.

39. A device in accordance with claim 1 wherein the cargo retaining base structure of the carrier device includes a multiplicity of openings.

40. A device in accordance with claim 1 wherein the support base retention base is constructed of a material which is at least partly flexible.

41. A device in accordance with claim 1 wherein the upwardly projecting stub walls include a multiplicity of openings.

42. A device in accordance with claim 1 wherein said upwardly projecting stub walls are constructed of at least a partly flexible material.

43. A device in accordance with claim 1 wherein the base includes receiving portions which permit selective removal and retention of equipment.

44. A device in accordance with claim 1 wherein one of at least two of said devices nests inside the perimeter of the other device, when both devices are in their second, stowed positions.

45. A device in accordance with claim 1 wherein at least one of said carrier device components is in the first operative position, and another at least one of said carrier device components are in the second, stowed position, and the said stowed carrier device is nested inside the base of the operative carrier device.
